(19) United States
(12) Patent Application Publication
(10) Pub. No.: US 2026/0291432 A1
(43) Pub. Date: Sep. 24, 2026

(54) SYSTEMS AND METHODS FOR ESTIMATING ELECTRIC PARAMETERS OF SOLAR MODULES OF A SOLAR ARRAY

(71) Applicant: MORGAN SOLAR INC., Toronto (CA)

(72) Inventor: Allan TAMESHTIT, Toronto (CA)

(21) Appl. No.: 19/476,032

(22) PCT Filed: Apr. 11, 2024
(86) PCT No.: PCT/CA2024/050458

§ 371 Date: Oct. 16, 2025

Related U.S. Application Data
(60) Provisional application No. 63/460,431, filed on Apr. 19, 2023.

(51) Int. Cl. H02S 50/10; G01J 5/00; G01J 5/48; G01K 7/02

(52) U.S. Cl. CPC H02S 50/10; G01J 5/48; G01K 7/02; G01J 2005/0077

(57) ABSTRACT

Systems and methods for monitoring a solar array. The solar array includes a first set of solar modules and a second set of solar modules. The system includes at least one first thermal sensor for measuring first thermal data of each solar module of the first set of solar modules, at least one data acquisition unit for measuring power data of each solar module of the first set of solar modules, at least one second thermal sensor for measuring second thermal data of each solar module of the second set of solar modules and a processor for calculating at least one adjustable parameter based on the first thermal data and the power data, wherein the processor utilizes the at least one adjustable parameter and the second thermal data to estimate at least one electric parameter of each of the solar modules of the second set of solar modules.

### CROSS-REFERENCE

The present application claims priority to U.S. Provisional Patent Application No. 63/460,431, entitled “Systems and Methods for Estimating Electric Parameters of Solar Modules of a Solar Array,” filed Apr. 19, 2023, the entirety of which is incorporated by reference herein.

### TECHNICAL FIELD

The present technology relates generally to solar arrays, and particularly to estimation of electric parameters of solar modules of the solar array.

### BACKGROUND

A solar array may typically include hundreds or thousands of solar modules, also referred to as solar panels. To produce the most electricity possible, it is important that every module in an array function properly. As solar modules get older, their efficiency may decrease for different reasons and fall below an acceptable tolerance. A malfunctioning module typically produces more heat than a normally operating module because the ratio of thermal to electrical energy produced by the former is greater than in the latter.

Systems have been developed to assess whether a given solar module is producing power at an adequate level. For example, a solar module may be electrically connected to a data acquisition system (DAQ) for this purpose in order to measure the electrical parameters of the module, such as current and voltage. Standard DAQs are costly however, and it is typically impractical to link a DAQ to each solar module of the solar array. As a result, in a commercial solar array, many modules-typically more than 80% of the total-do not have their electrical properties monitored.

There remains a desire to develop a cost-efficient system for monitoring solar modules of a solar array.

### SUMMARY

It is an object of the present technology to ameliorate at least some of the inconveniences present in the prior art.

According to a first broad aspect of the present technology, there is provided a computer readable medium containing program instructions for monitoring a solar array, the solar array including a first set of solar modules and a second set of solar modules. Said instructions cause a computer to perform the steps of receiving first thermal data of solar modules of the first set of solar modules that includes at least one of temperature data and infrared data, receiving, from data acquisition units in electrical communication with the first set of solar modules, each data acquisition unit being associated with and connected to one corresponding solar module of the first set of solar modules, power data that includes at least one of voltage data, current data and electrical power output data of the first set of solar modules, determining, based on the first thermal data and the power data of each of the solar module of the first set of solar modules, a value of at least one adjustable parameter, receiving second thermal data of the solar modules of the second set of solar modules that includes at least one of temperature data and infrared data and determining, based on the value of the at least one adjustable parameter and the second thermal data, an estimate of at least one electric parameter of each of the solar modules of the second set of solar modules.

In some non-limiting implementations, the at least one electric parameter is electromotive power produced by the solar module.

In some non-limiting implementations, said instructions further cause the computer to perform the steps of, in response to receiving the first thermal data, converting the first thermal data to a temperature of each of the solar modules of the first set of solar modules, in response to receiving the power data, converting the power data to power of each of the solar modules of the first set of solar modules and determining, based on the temperature and the power of each of the solar modules of the first set of solar modules, the value of the at least one adjustable parameter.

In some non-limiting implementations, the medium is non-transient.

In some non-limiting implementations, each of the data acquisition units includes a networking device to send wireless data to the computer.

In some non-limiting implementations, the at least one adjustable parameter includes at least one of an emissivity of the solar modules of the first set of solar modules, and a fraction of solar constant reaching the solar modules of the first set of solar modules.

According to a second broad aspect of the present technology, there is provided a system for monitoring a solar array, the solar array comprising a first set of solar modules and a second set of solar modules. The system includes at least one first thermal sensor for measuring first thermal data of each solar module of the first set of solar modules that includes at least one of temperature data and infrared data, at least one data acquisition unit for measuring power data of each solar module of the first set of solar modules, at least one second thermal sensor for measuring second thermal data of each solar module of the second set of solar modules that includes at least one of temperature data and infrared data and a processor for calculating at least one adjustable parameter based on the first thermal data and the power data, wherein the processor utilizes the at least one adjustable parameter and the second thermal data to estimate at least one electric parameter of each of the solar modules of the second set of solar modules.

In some non-limiting implementations, the at least one electric parameter includes electromotive power produced by the solar module.

In some non-limiting implementations, the at least one first thermal sensor coincides with the at least one second thermal sensor.

In some non-limiting implementations, the at least one first thermal sensor includes at least one of an infrared camera, a thermocouple and a thermometer.

In some non-limiting implementations, the system further includes a drone, wherein the at least one first thermal sensor includes an infrared camera carried by the drone.

In some non-limiting implementations, the system further includes a networking device for wirelessly transmitting the power data from the at least one data acquisition unit to the processor, wherein the processor is located in a server.

In some non-limiting implementations, the first thermal data and the power data are obtained within twenty-four hours of each other.

In some non-limiting implementations, the adjustable parameter includes at least one of an emissivity of the solar modules of the first set of solar modules, and a fraction of solar constant reaching the solar modules of the first set of solar modules.

In some non-limiting implementations, the processor models each of the solar modules of the second set of solar modules as a greybody to estimate the electromotive power.

According to a third broad aspect of the present technology, there is provided a method for monitoring a solar array, the solar array including a first set of solar modules and a second set of solar modules. The method includes receiving first thermal data of each solar module of the first set of solar modules that includes at least one of temperature data and infrared data, receiving power data of each of the solar modules of the first set of solar modules, wherein the power data is obtained with at least one data acquisition unit in electrical communication with the first set of solar modules, the power data including at least one of voltage data, current data and electrical power output, determining, based on the first thermal data and the power data, a value of at least one adjustable parameter, receiving second thermal data of each of the solar modules of the second set of solar modules that includes at least one of temperature data and infrared data and determining, based on the value of the at least one adjustable parameter and the second thermal data, an estimate of at least one electric parameter of each of the solar modules of the second set of solar modules.

In some non-limiting implementations, the at least one electric parameter is electromotive power generated by the solar module.

In some non-limiting implementations, the method further includes replacing, in response to the estimate of the at least one electric parameter of a given solar module of the second set of solar modules being outside a predetermined range value, the given solar module with a new solar module.

In some non-limiting implementations, receiving first thermal data includes receiving, from a thermal sensor comprising a thermal camera carried by a drone, information about infrared radiation of the first set of solar modules.

In some non-limiting implementations, receiving first thermal data includes utilizing a thermocouple to measure temperature of the first set of solar modules.

In some non-limiting implementations, the method further includes, in response to receiving the first thermal data, converting the first thermal data to a temperature of each solar module of the first set of solar modules, in response to receiving the power data, converting the power data to power of each solar module of the first set of solar modules, determining, based on the temperature and the power of each solar module of the first set of solar modules, the value of the at least one adjustable parameter, converting the second thermal data to a temperature of each solar module of the second set of solar modules and determining, based on the value of the at least one adjustable parameter and the temperature of each solar module of the second set of solar modules, an estimate of at least one electric parameter of the second set of solar modules.

In some non-limiting implementations, the at least one adjustable parameter includes at least one of an emissivity of the solar modules of the first set of solar modules, and a fraction of solar constant reaching the solar modules of the first set of solar modules.

According to a fourth broad aspect of the present technology, there is provided a computer readable medium containing program instructions for converting thermal data of a solar module into an estimate of electrical power produced therefrom, said instructions causing a computer to perform the steps of receiving thermal data of the solar module, said thermal data comprising information about a temperature of the solar module; receiving environmental data comprising information about a temperature of an environment in which the solar module is immersed; and determining, based on a) the temperature of the solar module, and b) the temperature of the environment.

In some non-limiting implementations, determining an estimate of the electromotive power produced by the solar module is further based on an emissivity of the solar module.

The instructions may cause the computer to further perform the steps of receiving information indicative of a size of an energy-collecting surface of the solar module; and determining, based on a) the information indicative of the size of the energy-collecting surface, b) an effective solar constant, and c) an angle formed by a ray from the sun and a normal to the energy-collecting surface, an estimated of the electrical power produced by the solar module.

Implementations of the present technology each have at least one of the above-mentioned objects and/or aspects, but do not necessarily have all of them. It should be understood that some aspects of the present technology that may have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Implementations will now be described more fully with reference to the accompanying drawings in which:

FIG. 1 is a schematic representation of a solar array in accordance with some non-limiting implementations of the present technology;

FIG. 2 is a block diagram of a data acquisition unit of the solar array of FIG. 1, in accordance with some non-limiting implementations of the present technology;

FIG. 3 is a block diagram of a data processing unit of the data acquisition unit of the FIG. 2, in accordance with some non-limiting implementations of the present technology; and

FIG. 4 is a flow diagram showing steps of a method for monitoring the solar array of FIG. 1, in accordance with some embodiments of the present technology.

Unless otherwise indicated, it should be noted that the Figures may not be drawn to scale.

### DETAILED DESCRIPTION

For a better understanding of various features of the present technology, reference is made to the following description and the accompanying figures. A person skilled in the art would understand that modifications to the implementations described below are possible and may be necessary for specific applications.

In the context of the present disclosure, a solar module is a system including one or more photovoltaic cells for converting sunlight into electricity. Each solar module defines a collecting surface (e.g. a rectangular surface) for receiving and capturing sunlight as a source of radiant energy. Said energy is further converted into electric energy. The solar modules of a solar array may be electrically connected to one another. The solar module may include lenses, prisms, diffusing elements, concentrators, or any other optical elements that are suitable for increasing a conversion ratio of the solar module. Optical elements may be movable with respect to a frame of the solar module and/or with respect to a support surface onto which the solar module is installed. In use, the solar module may rotate along one or more axes with respect to the support surface. For example, a rotation of the solar module may be pre-programmed such that a normal of a module collecting surface formed by the collecting surfaces of the one or more solar modules is parallel to incoming rays of the sun, or such that an angle between the two is minimized.

For illustrative purposes, a solar array may contain a total of M+N solar modules, M≥1 of the total being equipped with data acquisition units (DAQs), and the remaining N≥1 not equipped therewith. In one aspect of the instant invention, the electrical performances of the N solar modules are determined based on information obtained from the M solar modules.

In the context of the present disclosure, it is contemplated that a blackbody radiates energy, E, at a rate dE/dt that is given by the Stefan-Boltzmann law:

$$\frac{d E}{d t} = σ {T}^{4} A \qquad ( 1 )$$

where A is the surface area of the blackbody, T is its temperature, and σ is the Stefan-Boltzmann constant (σ=5.67 Wm⁻²K⁴).

To account for deviations from ideal blackbody behavior, an emissivity 0<ε≤1 is introduced, which generally depends on a material composition of the radiating body and its temperature. In the context of the present disclosure, it is assumed that the emissivity is constant with respect to the temperature for simplicity and ease of understanding. However, calculations and teachings disclosed herein may be adapted to obtain more realistic models in which the temperature dependence of the emissivity is taken into account in alternative implementations. As such, a rate at which a graybody radiates energy is given by:

$$\frac{d E}{d t} = ε σ {T}^{4} A \qquad ( 2 )$$

For a solar module, energy conservation suggests the following equation:

$$σ {T}_{m}^{4} A + {P}_{e m} = f S A cos θ + ε σ {T}_{e}^{4} A \qquad ( 3 )$$

where:
Tₘ is the temperature of the solar module,
A is the area of an energy-collecting surface of the solar module,
θ is the angle between sun's rays and a normal to the energy-collecting surface,
S is the solar flux just above the Earth's atmosphere assuming θ=0; an estimate of the solar flux that can be used for calculations is S=1350 W/m², although other estimates of the solar flux may instead be used; this latter value is the irradiance of the sun on the outer atmosphere when the sun and the Earth are separated by one astronomical unit—the mean earth/sun distance of 149,597,890 km—and is called the solar constant,
0<f≤1 is the fraction of the solar flux that reaches the Earth after the sun's radiation passes through the atmosphere (e.g., fS≅1000 W/m² for a clear day, where fS is referred to as the effective solar constant; alternatively, the effective solar constant may be determined by a dedicated sensor before performing the calculation in certain implementations),
Tₑ is the environmental temperature in a vicinity of the solar module, and
Pₑₘ is the electromotive power produced by the solar module.
   Eq. (3) represents a bookkeeping for energy: the left-hand side accounts for the energy produced by the solar module, both thermal and electromotive; the right-hand side accounts for the energy absorbed by the module, both from the sun and from environmental heat transfer.

For the M solar modules connected to DAQs, the electromotive power, Pₑₘ, produced by the solar cells can be measured with the DAQ. The environmental temperature Tₑ can be measured with a thermometer, θ can be ascertained from positional data such as the latitude of the location where the solar array is located, the date and time, GPS coordinates, etc. The temperature, Tₘ, of the solar module can be obtained from infrared data collected by an infrared camera mounted on a drone. Alternatively, other suitable techniques for obtaining the temperature of the module, such as by using a thermocouple, can be used to obtain Tₘ. The remaining variables, the emissivity ¿ and the solar fraction f, are experimental or calibration parameters that may be obtained using various methods.

One method uses data from the M solar modules to obtain ε and f. The second method uses data from the M solar modules to obtain just one of ε and f, the missing parameter obtained by some other means, such as published estimates. The third method does not obtain and f from the M solar modules. Instead, some other technique is used to obtain these parameters, such as obtaining the average module emissivity from the manufacturer, and obtaining f using separate solar flux measurements at ground level near the solar array, or alternatively, the fraction can be estimated from published tables of various cities. These methods will be expounded in more detail below.

Having obtained ε and f from the M solar modules (if the first or second methods are employed), these same values may be reused to estimate the electromotive power of the N solar modules using the following different version of Equation (3),

$${P}_{e m} = f S A cos θ + ε σ ( {T}_{e}^{4} - {T}_{m}^{4} ) A \qquad ( 4 )$$

It will be appreciated that the foregoing method allows one to obtain at least one electrical parameter (e.g. the electromotive power) of the N solar modules even though no DAQs are connected thereto.

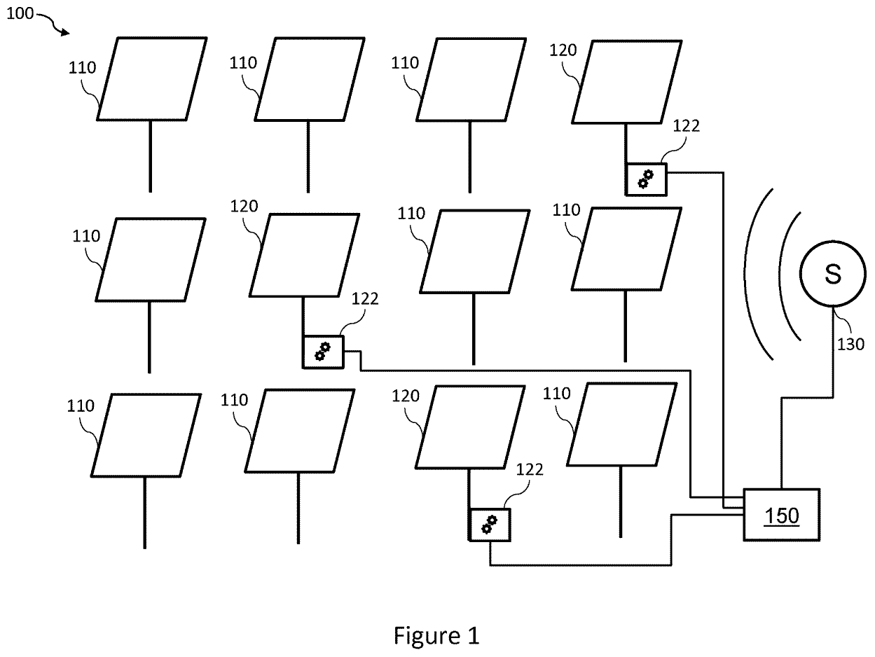

With reference to FIG. 1, one non-limiting implementation of a solar array 100 is described. The solar array 100 includes a plurality of solar modules; it is noted that the illustrated number is simply one possibility and is not meant to be limiting. In the present example, the solar array 100 includes M+N solar modules. As described above, a first set of M solar modules 120 is equipped with data acquisition units 122 for acquiring operation data therefrom (specifically three modules 120), while a second set of N solar modules 110 is not equipped with data acquisition units (specifically nine modules 110).

For a given solar module 120, the corresponding data acquisition unit 122 may acquire, for example and without limitation, a real electromotive power P_{em,0}, an electric current flowing to and/or from the solar module, a voltage thereof and/or components thereof, a temperature of the solar modules thereof (i.e. Tₘ), a temperature of an environment in a vicinity thereof (i.e. Tₑ) and/or any other operation parameter of the corresponding solar module 120. For example, the data acquisition unit 122 may include a thermometer, a thermocouple, an ammeter, a power-meter and/or a voltmeter.

As such, it can be said that the M solar modules 120 are directly monitored by a data acquisition system formed by the data acquisition units 122. As will be described herein after, data acquired by the data acquisition units 122 are used to determine at least one electric parameter of the N solar modules 110 of the solar array 100. More specifically, the solar array 100 includes a data processing unit 150 communicably connected to the data acquisition units 122. For example, the data acquisition units 122 may be communicatively coupled to the data processing unit 150 over a communication network via any wired or wireless communication link including, for example, 4G, LTE, Wi-Fi, or any other suitable connection. In some non-limiting implementations of the present technology, the communication network can be implemented as any wide-area communication network, local-area communication network, a private communication network and the like. The data processing unit 150 can include a remote processing unit (server or cloud-based server). How the communication links between the data acquisition units 122 and the data processing unit 150 are implemented will depend inter alia on how the data acquisition units 122 and the data processing unit 150 are implemented.

In some implementations, the solar array 100 further includes a temperature sensor 130 for acquiring temperature of any solar modules 110, 120 of the solar array 100. The temperature sensor 130 is communicably connected to the data processing unit 150 and may include an infrared camera carried by a flying system (e.g. a drone) hovering over the solar modules 110, 120. It should be noted that the temperature of a solar module that is performing below acceptable values is higher than the temperature of a solar module that is working at peak efficiency, all other factors being similar. As such, the temperature Tₘ of the N solar modules 110 may be determined by the temperature sensor 130, while the temperature Tₘ of the M solar modules 120 may be determined by the corresponding data acquisition units 122 and/or by the temperature sensor 130. For example, for a given solar module 120, a first temperature of the solar module 120 may be determined by the temperature sensors 130, and a second temperature of the solar module 120 may be determined by the corresponding data acquisition unit 122, the temperature Tₘ being, for example and without limitation, an average of the first and second temperatures (e.g. a weighted average).

In use, the data processing unit 150 determines an estimate of at least one electric parameter of the N solar modules 110 of the solar array 100. In this implementation, the data processing unit 150 estimates the electromotive power of each of the N solar modules 110 based on equation (4).

To do so, the data processing unit 150 receives first thermal data of the M solar modules 120 including information about a temperature Tₘ of each of the M solar modules 120. The first thermal data may be received from the data acquisition units 122 and/or from the temperature sensor 130.

In parallel or subsequently, the data processing unit 150 also receives power data of the M solar modules 120 including information about the at least one electric parameter (here the electromotive power Pₑₘ) of each of the M solar modules 120. The power data is received from the data acquisition units 122.

In parallel or subsequently, the data processing unit 150 also receives second thermal data of the N solar modules 110 including information about a temperature Tₘ of each of the N solar modules 110. Additionally, or alternatively, second thermal data is received from the temperature sensor 130.

For convenience, Equation (4) may be reformulated as:

$$π = ε σ ( {\tilde{T}}_{e}^{4} - {\tilde{T}}_{m}^{4} ) + f \qquad ( 5 )$$

where

$$π = \frac{{P}_{e m}}{S A cos θ}$$

is the scaled dimensionless power,

$$\tilde{{T}_{e}} = \frac{{T}_{e}}{{( S cos θ )}^{1 / 4}}$$

is a scaled environmental temperature and

$${\tilde{T}}_{m} = \frac{{T}_{m}}{{( S cos θ )}^{1 / 4}}$$

is a scaled solar module temperature. It should be noted that, in this implementation, the electric parameter to be estimated by the data processing unit 150 is electromotive power, π or Pₑₘ, but instead or in addition other electrical parameters such as electric current or voltage, may be estimated in alternative implementations. Thus, the scaled electromotive power π can be considered to be a function of \tilde{T}ₘ and two adjustable parameters, ε and f.

In an implementation, the data processing unit 150 executes an algorithm to obtain at least one of the two adjustable parameters ε and f. For example, and without limitation, a two-parameter linear least square analysis, or “χ² analysis,” may be used to determine the two adjustable parameters ε and f. Said algorithm is executed to minimize the following merit function:

$${χ}^{2} = {\sum }_{i = 1}^{M} {[ {π}_{i} - ε σ ( {\tilde{T}}_{e}^{4} - {\tilde{T}}_{m , i}^{4} ) - f ]}^{2} \qquad ( 6 )$$

It should be noted that the scaled electromotive power Tri used in equation (6) is based on real electromotive power P_{em,0} of the solar modules 120 measured by the data acquisition units 122. In other words, the M pairs of points (\tilde{T}_{m,i}, πᵢ) in the definition of the merit function represent the scaled temperature and scaled real electromotive power of the M solar modules 120 that are connected to the data acquisition units 122. In this implementation, the adjustable parameters are expected to minimize χ², which results in the derivatives of χ² with respect to E and f being equal to 0:

$$\{ \begin{matrix}{\sum }_{i = 1}^{M} [ {π}_{i} - ε σ ( {\tilde{T}}_{e}^{4} - {\tilde{T}}_{m , i}^{4} ) - f ] ( {\tilde{T}}_{e}^{4} - {\tilde{T}}_{m , i}^{4} ) = 0 ( 7 ) \\ {\sum }_{i = 1}^{M} [ {π}_{i} - εσ ( {\tilde{T}}_{e}^{4} - {\tilde{T}}_{m , i}^{4} ) - f ] = 0 ( 8 )\end{matrix}$$

Equations (7) and (8) may be written in a matrix form as:

$${A}^{T} A a = b \qquad ( 11 )$$

$$where A = σ ( \begin{matrix}{\tilde{T}}_{e}^{4} - {\tilde{T}}_{m , 1}^{4} & 1 \\ {\tilde{T}}_{e}^{4} - {\tilde{T}}_{m , 2}^{4} & 1 \\ ⋮ & ⋮ \\ {\tilde{T}}_{e}^{4} - {\tilde{T}}_{m , M}^{4} & 1\end{matrix} ) , a = ( \begin{matrix}ε \\ f\end{matrix} ) and b = {A}^{T} ( \begin{matrix}{π}_{1} \\ {π}_{2} \\ ⋮ \\ {π}_{M}\end{matrix} )$$

As such, the two adjustable parameters ε and f may be obtained by inverting the matrix A^{T}A according to α=(ATA)⁻¹b. The estimated electromotive power of the N solar modules 110 may then be determined by the data processing unit 150 using equation (4).

It can be said that, in one aspect, the data processing unit 150 uses the electrical and thermal properties of the M solar modules 120 equipped with data acquisition units 122 to model the relationship between the electrical properties of an arbitrary module in the array and its thermal characteristics. With this relationship, it is possible to estimate the electrical performance of the N solar modules 110 from their thermal data even if these N solar modules 110 are not connected to data acquisition units. Advantageously, this reduces the number of DAQs required in a solar array since information obtained from the DAQs of the M solar modules is used to obtain electrical parameters, such as electrical power, of the N solar modules that are not connected to DAQs.

In some implementations, the estimated electromotive power of the N solar modules 110 is compared with one or more pre-determined electromotive power thresholds. If one or more solar modules 110 have their respective estimated electromotive power below a minimum electromotive power threshold or above a maximum electromotive power threshold, the data processing unit 150 may identify said one or more solar modules 110 as failing. It should be noted that the pre-determined electromotive power thresholds may be adjusted, before the estimated electromotive power of the N solar modules 110 being compared thereto, based on, for example and without limitation, a temperature of the environment, an average of the electromotive power of the M solar modules 120, environmental conditions (e.g. current illuminance) and/or any other parameters. Broadly speaking, for a given solar module 110, the estimated electromotive power is compared to threshold to determine whether or not the given solar module 110 is failing. For example, in response to the estimated electromotive power of a given solar module 110 being outside a predetermined range (e.g. between the minimum electromotive power threshold and the maximum electromotive power threshold), an operator of the solar array 100 may determine that replacement of the given solar module 110 with a new solar module may be necessary.

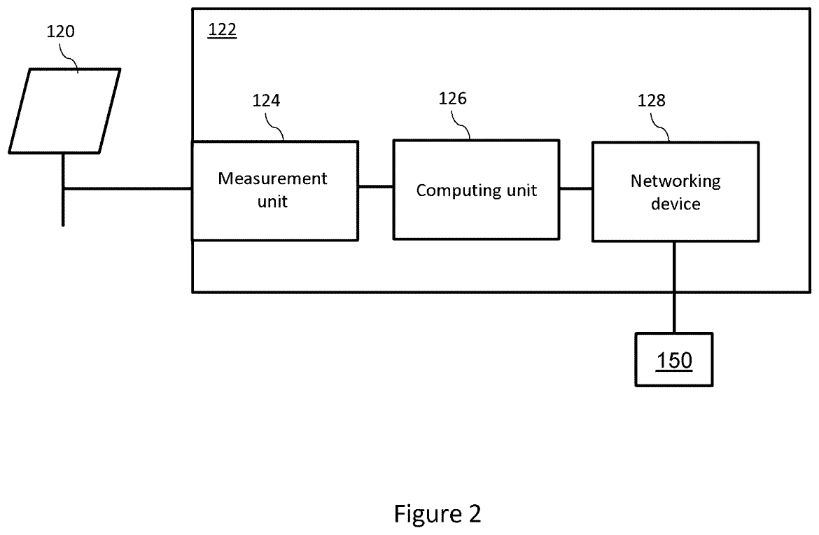

One non-limiting implementation of the data acquisition unit 122 is illustrated in FIG. 2. The data acquisition unit 122 includes a measurement unit 124 for acquiring operation parameters of the corresponding solar modules. The measurement unit 124 may include, for example and without limitations, a thermometer, a thermocouple, an ammeter, a power-meter and a voltmeter. The data acquisition unit 122 further includes a computing unit 126 to process the acquired operation parameters received from the measurement unit 124 and generate operation data of the solar modules 120. The computing unit 126 may be a general-purpose processor, such as a central processing unit (CPU) or a processor dedicated to a specific purpose, such as a digital signal processor (DSP). In some embodiments, the computing unit 126 may also rely on an accelerator dedicated to certain given tasks. In some embodiments, the computing unit 126 may be implemented as one or more field programmable gate arrays (FPGAs). Moreover, explicit use of the term “computing unit,” should not be construed to refer exclusively to hardware capable of executing software, and may implicitly include, without limitation, application specific integrated circuit (ASIC), read-only memory (ROM) for storing software, RAM, and non-volatile storage. Other hardware, conventional and/or custom, may also be included.

The data acquisition unit 122 further includes a networking device 128 to transmit the operation data to the data processing unit 150 of the solar array 100. As is noted above, the networking device 128 could be configured for connection through a variety of communication networks, both wired and wireless.

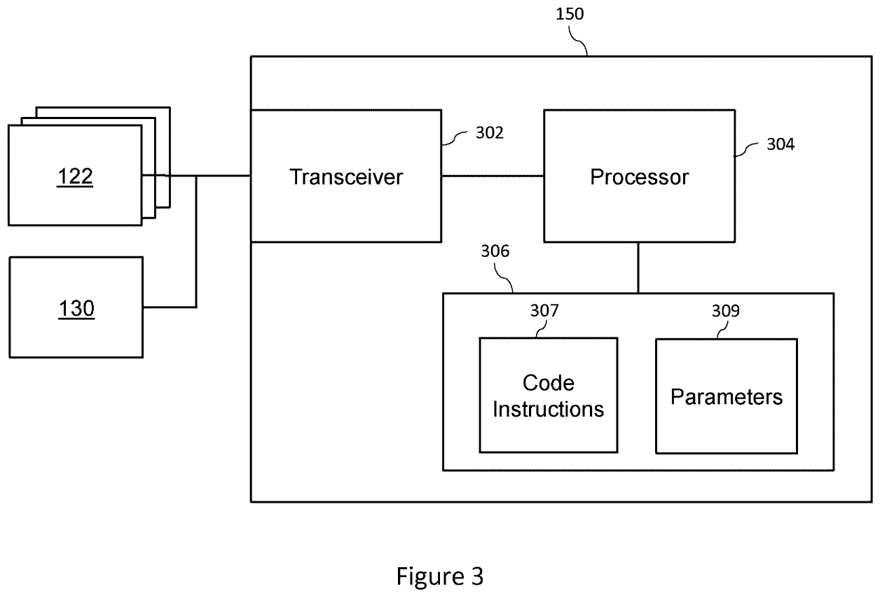

FIG. 3 is a schematic block diagram of the data processing unit 150 illustrating one embodiment according to the present technology. The data processing unit 150 includes a processor or a plurality of cooperating processors (represented as a processor 304 for simplicity), a memory device or a plurality of memory devices (represented as a memory device 306 for simplicity), and an input/output interface 302 allowing the data processing unit 150 to communicate with other components of the solar array 100 such as the data acquisition units 122. The processor 304 is operatively connected to the memory device 306 and to the input/output interface 302. The memory device 306 includes a storage for storing parameters 309, including for example and without limitation the above-mentioned solar flux S and the sizes of energy-collecting surfaces of the solar modules 110, 120. The memory device 306 may include a non-transitory computer-readable medium for storing code instructions 307 that are executable by the processor 304 to allow the data processing unit 150 to perform the various tasks allocated to the data processing unit 150 in methods described herein.

The data processing unit 150 is operatively connected, via the input/output interface 302, to the data acquisition units 122 and the thermal sensor 130. The data processing unit 150 executes the code instructions 307 stored in the memory device 306 to implement the various above-described functions that may be present in a particular embodiment.

In some implementations, the data processing unit 150 may be in part or entirely an “off the shelf” generic computer system or server. In some embodiments, the data processing unit 150 may also be distributed amongst multiple systems. The data processing unit 150 may also be specifically dedicated to the implementation of the present technology. As a person in the art of the present technology may appreciate, multiple variations as to how the data processing unit 150 is implemented may be envisioned without departing from the scope of the present technology.

In some implementations, the data processing unit 150 may further include a Human-Machine Interface (HMI) including a screen or a display capable of rendering an interface and indications of estimated electromotive power of the solar modules 110, indication of an identification of failing solar modules, and/or any other information suitable for monitoring the solar array 100. In some implementations, a display of the user interface may be implemented using a Liquid Crystal Display (LCD) display or a Light Emitting Diode (LED) display, such as an Organic LED (OLED) display. The device may be, for example and without being limitative, a handheld computer, a personal digital assistant, a cellular phone, a network device, a smartphone, a navigation device, an e-mail device, a game console, or a combination of two or more of these data processing devices or other data processing devices. The HMI may be embedded in the data processing unit 150 or located in an external physical location accessible to a user of the data processing unit 150.

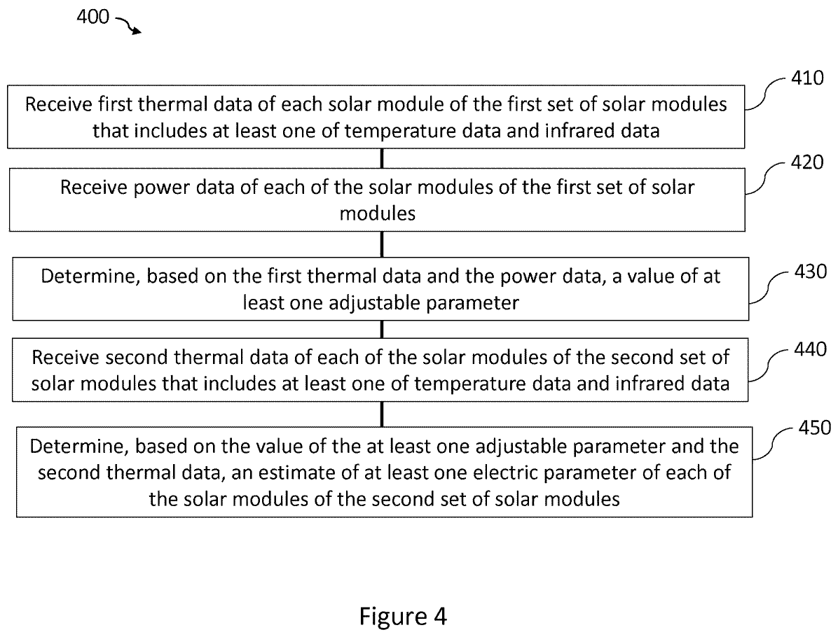

With reference to FIG. 4, a method 400 for monitoring the solar array 100 is illustrated in the form of a flowchart. It is of course contemplated that the method 400 could equally be applied to different implementations of solar arrays comprising a first set of solar modules connected to data acquisition system(s), and a second set of solar modules having no data acquisition system connected thereto. In one or more aspects, the method 400 is performed by the data processing unit 150 or any other device that may be communicably and operably connected to the optical link 105. In some implementations, one or more steps of the method 400 could be implemented, in whole or in part, by another computer-implemented device. It is also contemplated that the method 400 or one or more steps thereof may be embodied in computer-executable instructions that are stored in a computer-readable medium, such as a non-transitory mass storage device, loaded into memory and executed by a processor, such as the processor 304. Some steps or portions thereof in the flowchart may be executed concurrently, omitted or performed in a different order.

The method 400 starts by receiving, at step 410, first thermal data of each solar module of the first set of solar modules that includes at least one of temperature data and infrared data. In some implementations, the first thermal data includes information about a temperature Tₘ of each solar module of the first set of solar modules (e.g. the M solar modules 120). The first thermal data may be received from data acquisition units in electrical communication with the first set of solar modules, such as the data acquisition units 122, and/or from a temperature sensor, such as the temperature sensor 130. For example, and without limitations, the first thermal data may be collected by receiving, from a thermal sensor comprising a thermal camera carried by a drone, information about infrared radiation of the first set of solar modules. The thermal sensor may include a thermocouple to measure temperature of the first set of solar modules.

The method 400 continues with receiving, at step 420, power data of each of the solar modules of the first set of solar modules. The power data of a given solar module of the first set of solar modules is obtained with at least one corresponding data acquisition unit. The power data includes at least one of voltage data, current data and electrical power output.

The method 400 continues with determining, at step 430, based on the first thermal data and the power data, a value of at least one adjustable parameter. For example, and without limitations, the at least one adjustable parameter may be the two adjustable parameters ε and f described herein above, namely the emissivity ε of the solar modules of the first set of solar modules, and the fraction f of solar constant reaching the solar modules of the first set of solar modules.

The method 400 continues with receiving, at step 440, second thermal data of each of the solar modules of the second set of solar modules that includes at least one of temperature data and infrared data. In some implementations, the second thermal data includes information about a temperature Tₘ of each solar module of the second set of solar modules (e.g. the N solar modules 110). The second thermal data is received from the temperature sensor 130.

The method 400 ends with determining, at step 450, based on the value of the at least one adjustable parameter and the second thermal data, an estimate of at least one electric parameter of each of the solar modules of the second set of solar modules. For example, and without limitation, the at least one electric parameter may be an electromotive power generated by each of the N solar modules. In some embodiments, the emissivity ε may be equal to 1 (i.e. the solar modules are assumed to be blackbodies) such that the calculations presented herein are simplified. In these embodiments, the estimate of the electromotive power produced by the solar module is thus determined based on the temperature of the solar module and the temperature of the environment.

For example, the first thermal data may be converted to a temperature of each solar module of the first set of solar modules, or said temperature may be extracted from the first thermal data. Further, in response to receiving the power data, the power data may be converted to electrical power of each solar module of the first set of solar modules, or information about the electrical power may be extracted from the power data. The value of the at least one adjustable parameter may thus be determined based on the temperature and the power of each solar module of the first set of solar modules.

Furthermore, the second thermal data may be converted to a temperature of each solar module of the second set of solar modules, or information about said temperature may be extracted from the second thermal data. An estimate of at least one electric parameter of the second set of solar modules is further determined based on the value of the at least one adjustable parameter and the temperature of each solar module of the second set of solar modules.

In some implementations, the method 400 further includes, in response to the estimate of the at least one electric parameter of a given solar module of the second set of solar modules being outside a predetermined range value, replacing the given solar module with a new solar module.

It will be appreciated that at least some of the steps of the method 400 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

As described above, in a first method, a two parameter least squares fit can be undertaken to find the “best” ε and f. Alternatively, in a second method, data from the M solar modules is used to obtain just one of ε and f, the missing parameter obtained by some other means, such as published estimates. The one of ε and f may be obtained using a one-parameter least square analysis. The third method does not obtain ε and f from the M solar modules. Instead, some other technique is used to obtain these parameters, such as obtaining the average module emissivity from the manufacturer, and obtaining f using separate solar flux measurements at ground level near the solar array, or alternatively, the fraction can be estimated from published tables of various cities.

The solar array 100, the data processing units 150, the data acquisition units 122 described herein have several possible useful applications and/or technical solutions to challenges in the art. These could include but are not limited to the following applications, which could be implemented by one or more of the above described systems. It is understood that some minor adjustments to the implementations described above may be required.

Although implementations have been described above with reference to the accompanying drawings, those of skill in the art will appreciate that variations and modifications may be made without departing from the scope thereof as defined by the appended claims. For example, it will be appreciated that the controller described herein can include various processors that are proximal or remote from each other.

It should be appreciated that electrical properties that depend on the electrical power may also be estimated using the foregoing methods. For example, using the well-known expression P=IV, relating the current, voltage and power, any one of these three electrical properties can be estimated from knowledge of the other two. Moreover, a DAQ may measure the current of a module as a function of the voltage to obtain an IV curve. If the voltage of a module in the set of N (DAQless) modules is known, then estimating the module's power allows one to estimate the current via I=P/V. Varying the voltage in the module yields a table of IV values that can be plotted and otherwise further analyzed.

Modifications and improvements to the above-described implementations of the present technology may become apparent to those skilled in the art. The foregoing description is intended to be exemplary rather than limiting. For example, in addition to obtaining the electromotive power, Pₑₘ produced by the solar cells with a DAQ, the environmental temperature Tₑ with a thermometer, the angle θ from the latitude of the location where the solar array is located, the temperature, Tₘ of the solar module from infrared data collected by an infrared camera mounted or a thermocouple, other instruments or techniques can be used to obtain these data. The scope of the present technology is therefore intended to be limited solely by the scope of the appended claims.

What is claimed is:

1. A computer readable medium containing program instructions for monitoring a solar array, the solar array comprising a first set of solar modules and a second set of solar modules, said instructions causing a computer to perform the steps of:
receiving first thermal data of solar modules of the first set of solar modules that include at least one of temperature data and infrared data;
receiving, from data acquisition units in electrical communication with the first set of solar modules, each data acquisition unit being associated with and connected to one corresponding solar module of the first set of solar modules, power data that includes at least one of voltage data, current data and electrical power output data of the first set of solar modules;
determining, based on the first thermal data and the power data of each of the solar module of the first set of solar modules, a value of at least one adjustable parameter;
receiving second thermal data of the solar modules of the second set of solar modules that includes at least one of temperature data and infrared data; and
determining, based on the value of the at least one adjustable parameter and the second thermal data, an estimate of at least one electric parameter of each of the solar modules of the second set of solar modules.

2. The computer readable medium of claim 1, wherein the at least one electric parameter is electromotive power produced by the solar module.

3. The computer readable medium of claim 1, the instructions further cause the computer to perform the steps of:
in response to receiving the first thermal data, converting the first thermal data to a temperature of each of the solar modules of the first set of solar modules;
in response to receiving the power data, converting the power data to power of each of the solar modules of the first set of solar modules; and
determining, based on the temperature and the power of each of the solar modules of the first set of solar modules, the value of the at least one adjustable parameter.

4. The computer readable medium of claim 1, wherein the medium is non-transient.

5. The computer readable medium of claim 1, wherein each of the data acquisition units includes a networking device to send wireless data to the computer.

6. The computer readable medium of claim 1, wherein the at least one adjustable parameter comprises at least one of:
an emissivity of the solar modules of the first set of solar modules, and
a fraction of solar constant reaching the solar modules of the first set of solar modules.

7. A system for monitoring a solar array, the solar array comprising a first set of solar modules and a second set of solar modules, the system comprising:
at least one first thermal sensor for measuring first thermal data of each solar module of the first set of solar modules that includes at least one of temperature data and infrared data;
at least one data acquisition unit for measuring power data of each solar module of the first set of solar modules;
at least one second thermal sensor for measuring second thermal data of each solar module of the second set of solar modules that includes at least one of temperature data and infrared data; and
a processor for calculating at least one adjustable parameter based on the first thermal data and the power data, wherein the processor utilizes the at least one adjustable parameter and the second thermal data to estimate at least one electric parameter of each of the solar modules of the second set of solar modules.

8. The system of claim 7, wherein the at least one electric parameter includes electromotive power produced by the solar module.

9. The system of claim 7, wherein the at least one first thermal sensor coincides with the at least one second thermal sensor.

10. The system of claim 9, wherein the at least one first thermal sensor includes at least one of an infrared camera, a thermocouple and a thermometer.

11. The system of claim 9, further comprising a drone, wherein the at least one first thermal sensor comprises an infrared camera carried by the drone.

12. The system of claim 7, further comprising a networking device for wirelessly transmitting the power data from the at least one data acquisition unit to the processor, wherein the processor is located in a server.

13. The system of claim 7, wherein the first thermal data and the power data are obtained within twenty-four hours of each other.

14. The system of claim 7, wherein the adjustable parameter includes at least one of:
an emissivity of the solar modules of the first set of solar modules, and
a fraction of solar constant reaching the solar modules of the first set of solar modules.

15. The system of claim 8, wherein the processor is configured to model each of the solar modules of the second set of solar modules as a greybody to estimate the electromotive power.

16. A method for monitoring a solar array, the solar array comprising a first set of solar modules and a second set of solar modules, the method comprising:
receiving first thermal data of each solar module of the first set of solar modules that includes at least one of temperature data and infrared data;
receiving power data of each of the solar modules of the first set of solar modules, wherein the power data is obtained with at least one data acquisition unit in electrical communication with the first set of solar modules, the power data including at least one of voltage data, current data and electrical power output data;
determining, based on the first thermal data and the power data, a value of at least one adjustable parameter;
receiving second thermal data of each of the solar modules of the second set of solar modules that includes at least one of temperature data and infrared data; and
determining, based on the value of the at least one adjustable parameter and the second thermal data, an estimate of at least one electric parameter of each of the solar modules of the second set of solar modules.

17. The method of claim 16, wherein the at least one electric parameter is electromotive power generated by the solar module.

18. The method of claim 16, further comprising the step of:
replacing, in response to the estimate of the at least one electric parameter of a given solar module of the second set of solar modules being outside a predetermined range value, the given solar module with a new solar module.

19. The method of claim 16, wherein receiving first thermal data comprises:
receiving, from a thermal sensor comprising a thermal camera carried by a drone, information about infrared radiation of the first set of solar modules.

20. The method of claim 16, wherein receiving first thermal data comprises:
utilizing a thermocouple to measure temperature of the first set of solar modules.

21. The method of claim 16, further comprising:
in response to receiving the first thermal data, converting the first thermal data to a temperature of each solar module of the first set of solar modules;
in response to receiving the power data, converting the power data to power of each solar module of the first set of solar modules;
determining, based on the temperature and the power of each solar module of the first set of solar modules, the value of the at least one adjustable parameter;
converting the second thermal data to a temperature of each solar module of the second set of solar modules; and
determining, based on the value of the at least one adjustable parameter and the temperature of each solar module of the second set of solar modules, an estimate of at least one electric parameter of the second set of solar modules.

22. The method of claim 16, wherein the at least one adjustable parameter comprises at least one of:
an emissivity of the solar modules of the first set of solar modules, and
a fraction of solar constant reaching the solar modules of the first set of solar modules.

23. A computer readable medium containing program instructions for converting thermal data of a solar module into an estimate of electrical power produced therefrom, said instructions causing a computer to perform the steps of:
receiving thermal data of the solar module, said thermal data comprising information about a temperature of the solar module;
receiving environmental data comprising information about a temperature of an environment in which the solar module is immersed; and
determining, based on a) the temperature of the solar module and b) the temperature of the environment, an estimate of the electromotive power produced by the solar module.

24. The computer readable medium of claim 23, wherein the step of determining an estimate of the electromotive power produced by the solar module is further based on an emissivity of the solar module.

25. The computer readable medium of claim 23, wherein said instructions further cause the computer to perform the steps of:
receiving information indicative of a size of an energy-collecting surface of the solar module; and
determining, based on a) the information indicative of the size of the energy-collecting surface, b) an effective solar constant, and c) an angle formed by a ray from the sun and a normal to the energy-collecting surface, an estimate of the electrical power produced by the solar module.
